(19) United States
(12) Patent Application Publication
(10) Pub. No.: US 2025/0019005 A1
(43) Pub. Date: Jan. 16, 2025

(54) PROTECTIVE STRUCTURE

(71) Applicant: SUBARU CORPORATION, Tokyo (JP)

(72) Inventors: Kentaro KAMEI, Tokyo (JP); Yoshio WADA, Tokyo (JP); Hisayuki NAGATSU, Tokyo (JP)

(21) Appl. No.: 18/748,831

(22) Filed: Jun. 20, 2024

(30) Foreign Application Priority Data
Jul. 12, 2023 (JP) 2023-114474

(51) Int. Cl. B62D 25/08; B62D 27/06

(52) U.S. Cl. CPC B62D 25/082; B62D 27/065

(57) ABSTRACT

A protective structure includes a frame, a base, a first bracket, and a second bracket. The frame forms a skeleton of a vehicle. The base is configured to disperse an impact due to a collision to the frame when the collision occurs. The first bracket is fixed to the base. The second bracket fixes and supports a protection target member to be protected from an impact due to the collision, the second bracket being fixed to the first bracket. The second bracket includes a contact portion protruding toward an adjacent member disposed adjacent to the second bracket. At least a part of the contact portion and a part of the first bracket overlap each other as viewed from a side where the contact portion protrudes.

### CROSS-REFERENCE TO RELATED APPLICATIONS

The present application claims priority from Japanese Patent Application No. 2023-114474 filed on Jul. 12, 2023, the entire contents of which are hereby incorporated by reference.

### BACKGROUND

The disclosure relates to a protective structure.

In recent years, with the spread of electric vehicles, when a vehicle is a hybrid vehicle, an electric vehicle, or the like, an inverter unit that converts a DC voltage into an AC voltage may be mounted in a front part of the vehicle in order to drive an electric motor.

For example, in the inverter unit, a high voltage for traveling of the vehicle is generated, and there is a possibility that a sudden abnormal reaction occurs when deformation or disconnection occurs due to a front collision or the like of the vehicle.

Thus, there is a demand for a structure that reduces an influence on a device that uses a high voltage such as an inverter or an air compressor when a collision occurs in a vehicle.

As a technique corresponding to the problem described above, since a gap between the air compressor as an auxiliary machine and a bracket is the narrowest in the vicinity of an upper attachment part, the upper attachment part having relatively low rigidity is deformed when the vehicle collides forward, and the air compressor rotates with respect to the bracket with the lower attachment part having relatively high rigidity as a fulcrum. A technique is disclosed in which a bracket abuts on an air compressor at a portion where the gap between the air compressor and the bracket is narrowest, thereby suitably suppressing falling of the air compressor due to an impact at the time of a front collision of a vehicle (see, for example, Japanese Patent No. 6090185).

### SUMMARY

An aspect of the disclosure provides a protective structure. The protective structure includes a frame, a base, a first bracket, and a second bracket. The frame forms a skeleton of a vehicle. The base is configured to disperse an impact due to a collision to the frame when the collision occurs. The first bracket is fixed to the base. The second bracket fixes and supports a protection target member to be protected from an impact due to the collision. The second bracket is fixed to the first bracket. The second bracket includes a contact portion protruding toward an adjacent member disposed adjacent to the second bracket. At least a part of the contact portion and a part of the first bracket overlap each other as viewed from a side where the contact portion protrudes.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a perspective view of a vehicle to which a protective structure according to an embodiment of the disclosure is applied as viewed from above;

FIGS. 2A to 2C are three views illustrating a protective structure according to an embodiment of the disclosure, in which FIG. 2A is a plan view as viewed from above, FIG. 2B is a front view, and FIG. 2C is a side view as viewed from a right side;

FIG. 3 is an enlarged perspective view of a contact portion in the protective structure according to the embodiment of the disclosure as viewed from an upper side; and

FIGS. 4A to 4C are side views illustrating operations when a collision occurs in the protective structure according to the embodiment of the disclosure in chronological order in FIGS. 4A to 4C.

### DETAILED DESCRIPTION

In the technique described in Japanese Patent No. 6090185, collision energy is concentrated on one point of an upper attachment part having relatively low rigidity at the time of a front collision of a vehicle, and the upper attachment part is damaged, thereby preventing the air compressor as an auxiliary machine to be protected from coming off.

However, the technique described in Japanese Patent No. 6090185 has a problem that, when a collision occurs in the vehicle, members disposed adjacent to each other may interfere with a device to be protected.

It is desirable to provide a protective structure that effectively prevents interference with a device to be protected when a collision occurs in a vehicle.

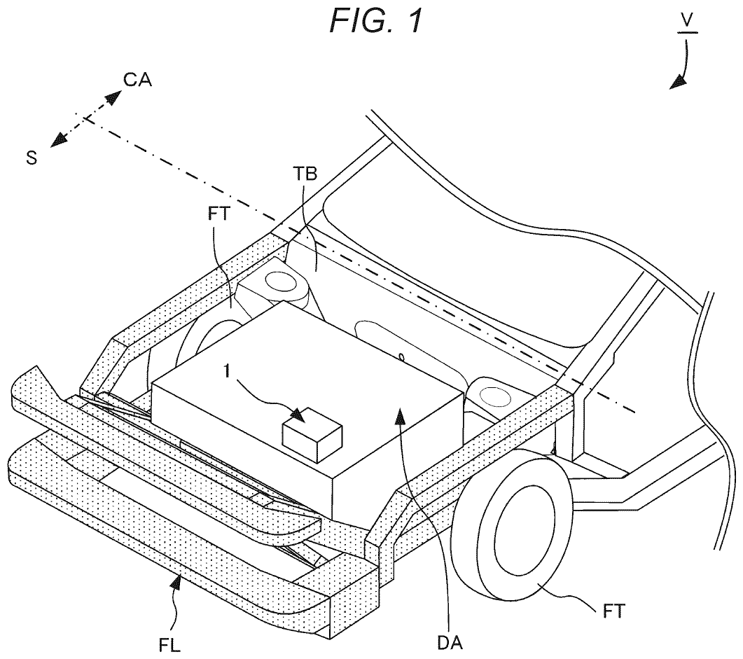

Hereinafter, a protective structure 1 according to the present embodiment will be described with reference to FIGS. 1 to 4C. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

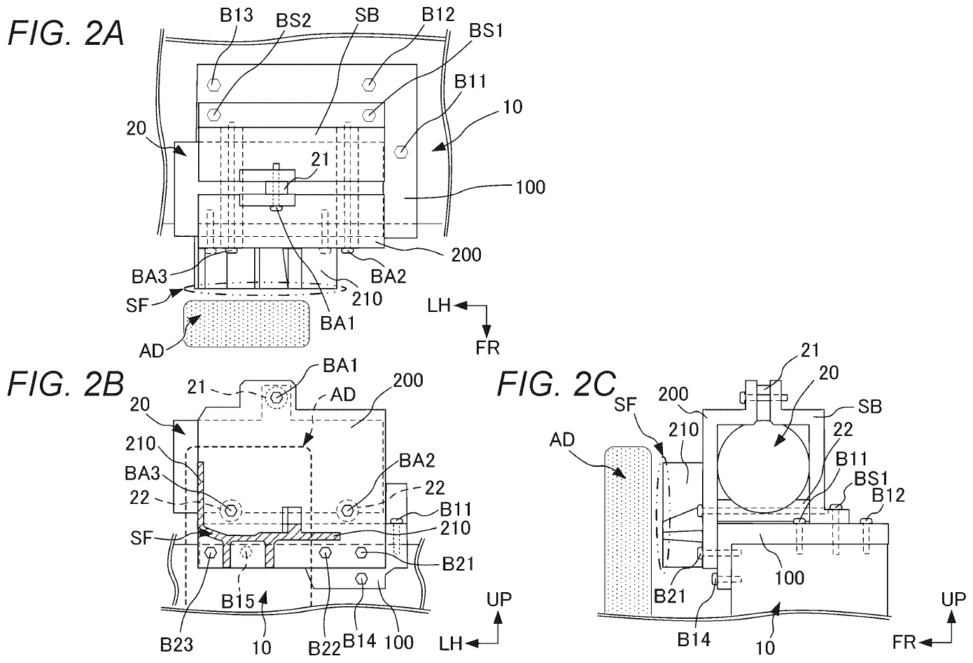

Note that, as illustrated in FIGS. 2A to 2C, an arrow FR illustrated in the drawings indicates a front side of the protective structure 1, an arrow UP indicates an upper side of the protective structure 1 as viewed from the front side, and an arrow LH indicates a left side of the protective structure 1 as viewed from the front side. In addition, in the following description, when description is made using up and down, front and rear, and left and right directions, unless otherwise specified, an up and down direction when the protective structure 1 is viewed from the front side, a front and rear direction when the front side of the protective structure 1 is the front, and a left and right direction when the protective structure 1 is viewed from the front side are indicated.

### Embodiment

A configuration of a protective structure 1 according to the present embodiment will be described with reference to FIGS. 1 to 3.

### <Vehicle Front Structure S>

In a vehicle V, as illustrated in FIG. 1, a vehicle front structure S is formed on a vehicle front side of a cabin CA as a vehicle interior on which an occupant gets. The vehicle front structure S is provided on a vehicle front side of a toe board TB. The vehicle front structure S includes a frame FL and a drive unit DA.

### (Frame FL)

As illustrated in a dot hatched portion of FIG. 1, the frame FL is coupled in a parallel cross shape in a vehicle width direction and a vehicle front and rear direction in the vehicle front structure S. The frame FL is a skeleton of the vehicle V, and is formed by a strong metal or the like having a substantially rectangular closed cross-sectional shape.

The frame FL protects the cabin CA and the drive unit DA by absorbing and dispersing an impact of a collision in the frame FL when the collision occurs.

### (Drive Unit DA)

The drive unit DA is disposed in a region of the vehicle front structure S, and is surrounded by the toe board TB and the frame FL.

The drive unit DA includes, for example, a power unit including a vehicle driving motor in an internal combustion engine or an electric vehicle that drives the front wheel FT, and is a drive device provided with a transmission, a clutch, a drive shaft, and the like.

The drive unit DA is firmly fixed to the frame FL.

### <Protective Structure 1>

The protective structure 1 is a structure applied to, for example, a device constituting the drive unit DA that drives the front wheel FT of the vehicle V.

As illustrated in FIGS. 2A to 2C, the protective structure 1 includes a base 10, a lower bracket 100 as a first bracket, a front bracket 200 as a second bracket, and a sub bracket SB.

In the drive unit DA, an adjacent member AD is disposed adjacent to the front bracket 200 on the front side of the protective structure 1. The adjacent member AD is, for example, an oil filter or an oil cooler.

The adjacent member AD is a collision object to the protective structure 1 when a collision occurs in the vehicle V.

Inside the protective structure 1, as a protection target member, for example, an air compressor 20 as a device that uses a high voltage is fixed to the base 10 via the front bracket 200 and the sub bracket SB.

For example, the front bracket 200 is provided on a front side of the protective structure 1 of the air compressor 20, and the sub bracket SB is provided on a rear side of the protective structure 1 of the air compressor 20. A pedestal 21 and a pedestal 22 are formed on an upper side and a lower side of the air compressor 20.

The air compressor 20 is fixed by bolts or the like via the pedestal 21 and the pedestal 22 in a state of being sandwiched between the front bracket 200 and the sub bracket SB in the front and rear direction of the protective structure 1. The air compressor 20 is fixed to the base 10 via the front bracket 200 and the sub bracket SB.

### (Base 10)

The base 10 is, for example, an internal combustion engine provided in the drive unit DA, and is configured to disperse an impact caused by the collision to the frame FL when the collision occurs. The base 10 is firmly fixed to the frame FL.

### (Sub Bracket SB)

The sub bracket SB is provided on the rear side of the protective structure 1 of the air compressor 20, sandwiches the air compressor 20 between the front bracket 200 and the sub bracket SB, and fixes the air compressor 20 in the front and rear direction of the protective structure 1 with a bolt or the like.

The sub bracket SB is fixed to the base 10 with a bolt or the like via the lower bracket 100 on the rear side of the protective structure 1.

The sub bracket SB is, for example, a cast formed by a strong member such as metal.

### (Lower Bracket 100)

The lower bracket 100 as the first bracket is fixed to the base 10.

The lower bracket 100 is, for example, a cast formed by a strong member such as metal.

As illustrated in FIG. 2C, the lower bracket 100 is placed on an upper side of the base 10 and is provided to cover the lower side of the air compressor 20. A front side of the protective structure 1 of the lower bracket 100 is bent in a substantially L shape along the base 10.

The lower bracket 100 is fixed to the base 10 with a bolt or the like.

Bolt holes penetrating from an upper side to a lower side is provided on an upper side of the lower bracket 100, and is fixed to the base 10 by bolts B11 to B13 as illustrated in FIG. 2A.

Bolt holes penetrating from a front side to a rear side of the protective structure 1 are provided on the front side of the protective structure 1 of the lower bracket 100, and is fixed to the base 10 by bolts B14 to B15 as illustrated in FIG. 2B.

The lower bracket 100 is provided with bolt holes through which the front bracket 200 and the sub bracket SB are fixed to the base 10 with a bolt or the like.

### (Front Bracket 200)

The front bracket 200 as the second bracket fixedly supports the air compressor 20 as the protection target member, and is fixed to the base 10 via the lower bracket 100.

The front bracket 200 is formed by a cast formed by a strong member such as metal, for example. The front bracket 200 is disposed on the front side of the protective structure 1 of the air compressor 20, and is provided so as to cover the up and down and left and right directions of the air compressor 20.

The front bracket 200 is provided with bolt holes penetrating from the front side to the rear side of the protective structure 1 for fixing the air compressor 20. In the front bracket 200, the bolts BA1 to BA3 pass through the pedestal 21 and the pedestal 22, and the air compressor 20 is fixed by being sandwiched between the front bracket 200 and the sub bracket SB.

Bolt holes penetrating from the front side to the rear side of the protective structure 1 is provided on the front side of the front bracket 200. As illustrated in FIG. 2B, the front bracket 200 penetrates the lower bracket 100 and is fixed to the base 10 by bolts B21 to B23. The front bracket 200 is fixed to the base 10 in surface contact with the lower bracket 100.

The bolts B21 to B23 fixing the front bracket 200 to the base 10 are directed in directions different from the bolts B11 to B13 fixing the lower bracket 100 to the base 10. For example, the bolts B21 to B23 are disposed from the front side to the rear side in the protective structure 1, and the bolts B11 to B13 are disposed from the upper side to the lower side as illustrated in FIG. 2C.

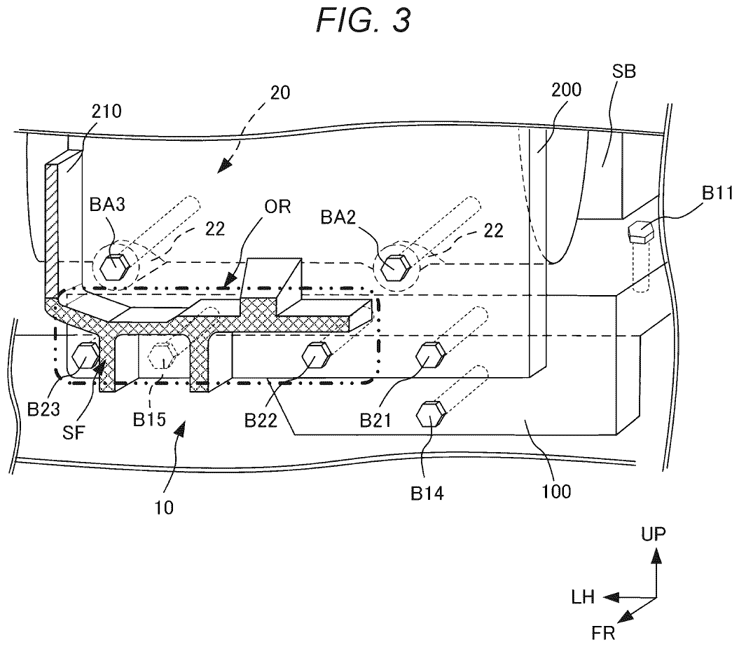

As illustrated in FIG. 3, the front bracket 200 is formed with a contact portion 210 protruding toward the adjacent member AD disposed adjacent to the front bracket 200.

The contact portion 210 is formed permanently integrally with the front bracket 200 by a strong member such as metal.

The contact portion 210 extends in the up and down direction at a left end portion of the protective structure 1 as viewed from the front side, and is bent in a right direction below the bolt BA3. In the contact portion 210, a rib directed in the up and down direction is formed on the right side of the bolt B23 and between the bolt BA2 and the bolt BA3.

In the contact portion 210, as illustrated in a hatched portion in FIG. 3, a contact surface SF is formed at a front end portion of the protective structure 1. The contact surfaces SF is formed in the same plane.

The bolts B21 to B23 fixing the front bracket 200 are oriented in a direction orthogonal to the contact surface SF. For example, the contact surface SF has a surface shape in the up and down and left and right directions when viewed from the front side of the protective structure 1. The bolts B21 to B23 fix the front bracket 200 in the front and rear direction in the protective structure 1. Therefore, the bolts B21 to B23 are directed in the direction orthogonal to the contact surface SF.

An overlapping portion OR where at least parts of the contact portion 210 and the lower bracket 100 overlap when viewed from the front side of the protective structure 1 is provided on the rear side of the contact portion 210. For example, at the overlapping portion OR, as indicated by a thick two-dot chain line in FIG. 3, the front bracket 200 and the lower bracket 100 are in surface contact with each other on the rear side of the contact portion 210. The front bracket 200, the lower bracket 100, and the base 10 are firmly fixed by the bolts B14 to B15 and the bolts B21 to B23.

In the range indicated by the cross-hatched portion in FIG. 3 in the overlapping portion OR, the lower bracket 100 is disposed to overlap the rear side of the protective structure 1 of the contact portion 210.

### Action and Effect

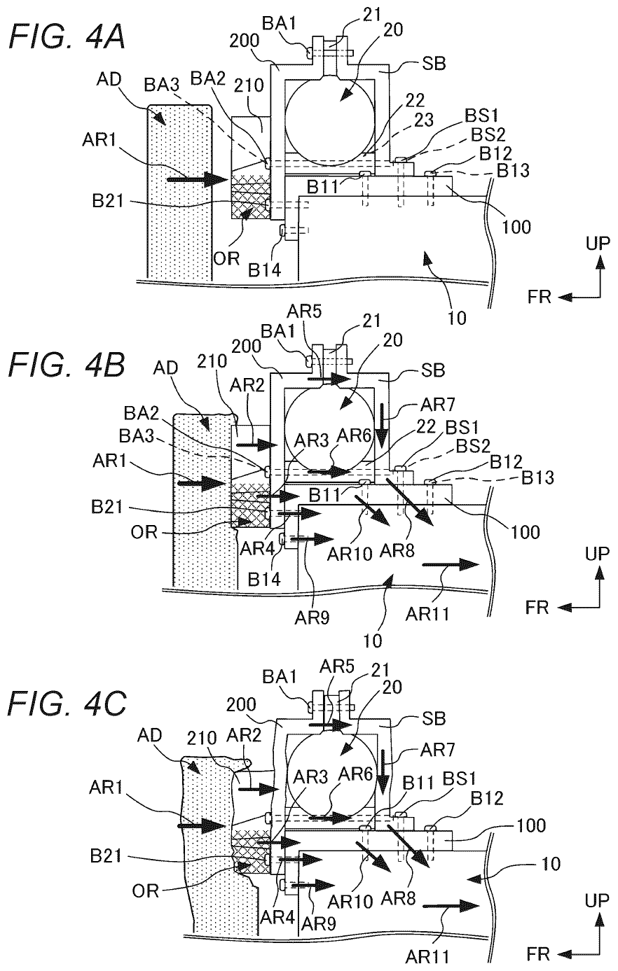

In the protective structure 1 according to the present embodiment configured as described above, an operation when a collision occurs in the vehicle V and, for example, the adjacent member AD collides in a direction indicated by an arrow AR1 in FIG. 4A will be described with reference to FIGS. 4A to 4C.

When a collision occurs in the vehicle V and the adjacent member AD collides in the direction indicated by the arrow AR1, the collision energy is transmitted in the direction indicated by the arrow AR1 in FIG. 4A.

The adjacent member AD collides with the contact portion 210 of the front bracket 200. As illustrated in FIG. 4B, the collision energy is transmitted to the rear side of the protective structure 1 while being dispersed in directions indicated by an arrow AR2, an arrow AR3, and an arrow AR4.

The collision energy in the direction of the arrow AR2 is transmitted from the front bracket 200 to the sub bracket SB via the pedestal 21 and the pedestal 22 in a direction indicated by an arrow AR5 and an arrow AR6. The collision energy transmitted to the sub bracket SB is transmitted to the base 10 in a direction indicated by an arrow AR7 and is absorbed via the lower bracket 100 in a direction indicated by an arrow AR8.

The collision energy in the direction of the arrow AR3 is transmitted to an upper surface of the lower bracket 100 via the front bracket 200. The collision energy is transmitted to the base 10 by the bolts B11 to B13 fixing the upper surface of the lower bracket 100 and the base 10 and the bolts BS1 and BS2 fixing the sub bracket SB, the lower bracket 100, and the base 10.

The bolts B21 to B23 fixing the front bracket 200 to the base 10 are directed in directions different from the bolts B11 to B13 fixing the lower bracket 100 to the base 10. Further, the bolts BA1 to BA3 fixing the front bracket 200 to the sub bracket SB are directed in directions different from the bolts BS1 and BS2 fixing the sub bracket SB to the base 10.

For example, the bolts B11 to B13 and the bolts BS1 and BS2 are fixed to the base 10 from the upper side to the lower side. The collision energy transmitted to the upper surface of the lower bracket 100 is transmitted to the base 10 via the bolts B11 to B13 and the bolts BS1 and BS2. Therefore, the collision energy is dispersed from the direction indicated by the arrow AR3 to the direction indicated by the arrow AR8 or an arrow AR10 and transmitted to the base 10.

Furthermore, front side surfaces of the front bracket 200 and the lower bracket 100 are in close contact with the base 10, thereby restricting movement of the upper side surface of the lower bracket 100 toward the rear side.

Therefore, the collision energy toward the rear side in the protective structure 1 applied to the bolts B11 to B13 and BS 1 to BS 2 fixing the lower bracket 100 to the base 10 is limited.

The collision energy directed in the direction of the arrow AR4 is transmitted to a front side surface of the protective structure 1 of the lower bracket 100 via the front side surface of the protective structure 1 of the front bracket 200, and is transmitted to the base 10.

The bolts B21 to B23 fixing the front bracket 200 are oriented in a direction orthogonal to the contact surface SF. For example, the bolts B21 to B23 fix the front bracket 200 linearly in the direction in which the contact portion 210 protrudes. Therefore, the collision energy transmitted from the contact portion 210 is efficiently transmitted to the base 10 linearly in the direction of the arrow AR4 via the bolts B21 to B23.

A part of the collision energy directed in the direction of the arrow AR4 is transmitted to the base 10 in a direction indicated by an arrow AR9 on the lower side of the lower bracket 100 fixed to the base 10 by the bolts B14 to B15.

The collision energy in the direction of the arrow AR3 and the arrow AR4 is transmitted via the overlapping portion OR where the contact portion 210 and the lower bracket 100 of the front bracket 200 overlap.

In the overlapping portion OR, the front bracket 200, the lower bracket 100, and the base 10 are in surface contact with each other on the front side of the protective structure 1, and are firmly fixed by the bolts B21 to B23. The lower bracket 100 and the base 10 are further firmly fixed by bolts B14 to B15.

The bolts B21 to B23 and the bolts B14 to B15 are fixed to the lower bracket 100 and the base 10 from the front side to the rear side in the protective structure 1. The collision energy transmitted to the front bracket 200 is transmitted to the base 10 via the bolts B21 to B23 and the bolts B14 to B15.

Furthermore, since the front bracket 200, the lower bracket 100, and the base 10 are in surface contact with each other, the collision energy transmitted to the contact portion 210 is transmitted to the lower bracket 100 and the base 10 in the directions of the arrows AR3 and AR4.

Therefore, in the overlapping portion OR, the collision energy transmitted to the contact portion 210 is efficiently and linearly transmitted to the base 10 and absorbed by the base 10 and the frame FL.

Further, when the collision energy is transmitted from the adjacent member AD, as illustrated in FIG. 4C, the collision energy is transmitted toward the rear side of the protective structure 1 while deforming the contact portion 210 and the front bracket 200. When the lower bracket 100 and the base 10 are compressed in the directions of the arrows AR3 and AR4, the collision energy is absorbed.

The collision energy transmitted to the contact portion 210 is further dispersed to the lower bracket 100 and the sub bracket SB via the bolts B21 to B23 and the bolts BA1 to BA3 fixing the front bracket 200. The collision energy transmitted to the lower bracket 100 is further dispersed in the base 10 via the bolts B11 to B15. The collision energy transmitted to the sub bracket SB is further dispersed to the lower bracket 100 and the base 10 via the bolts BS1 and BS2.

Then, the collision energy is transmitted to the base 10 while being dispersed in directions indicated by the arrows AR2 to AR10.

The collision energy transmitted to the base 10 is transmitted in a direction indicated by an arrow AR11 and absorbed by the frame FL.

Then, the movement of the adjacent member AD is stopped by the protective structure 1, and the transmission of the collision energy is terminated.

As described above, when a collision occurs in the vehicle V and the adjacent member AD collides with the protective structure 1, for example, the contact portion 210 receives collision energy, and the protective structure 1 transmits the collision energy to the base 10 while dispersing the collision energy in the pedestal 21 and the pedestal 23 of the air compressor 20, the sub bracket SB, and the lower bracket 100.

Then, the protective structure 1 transmits the collision energy to the base 10 while dispersing the collision energy, thereby causing the base 10 to absorb the collision energy without interfering the adjacent member AD with the air compressor 20 as a protection target member.

As described above, the protective structure 1 according to the present embodiment includes the frame FL forming a skeleton of the vehicle V, the base 10 configured to disperse an impact due to a collision to the frame FL when the collision occurs, the lower bracket 100 as the first bracket fixed to the base 10, and the front bracket 200 as the second bracket fixing and supporting the air compressor 20 as a protection target member to be protected from an impact due to a collision, the front bracket 200 being fixed to the lower bracket 100 and being fixed to the base 10 via the lower bracket 100, in which the front bracket 200 includes the contact portion 210 protruding toward the adjacent member AD disposed adjacent to the front bracket 200, and at least parts of the contact portion 210 and the lower bracket 100 overlap in the overlapping portions OR as viewed from the side where the contact portion 210 protrudes.

That is, when a collision occurs in the vehicle V and the adjacent member AD collides with the protective structure 1, for example, the collision energy is transmitted to the contact portion 210 provided in the front bracket 200. The protective structure 1 transmits the collision energy transmitted from the contact portion 210 to the front bracket 200 to the base 10 while dispersing the collision energy to the bolts B11 to B15 fixing the lower bracket 100 and the base 10 and the bolts B21 to B23 fixing the front bracket 200 and the lower bracket 100. Furthermore, at the overlapping portion OR, the front bracket 200 provided with the contact portion 210 is in surface contact with the base 10 via the lower bracket 100, and the front bracket 200, the lower bracket 100, and the base 10 are firmly fixed by bolts. In the overlapping portion OR, the collision energy transmitted to the contact portion 210 is efficiently and linearly transmitted to the base 10 and absorbed by the base 10 and the frame FL.

Therefore, the protective structure 1 can disperse collision energy from the front bracket 200 provided with the contact portion 210 via the bolts B11 to B15 and the bolts B21 to B23 fixing the lower bracket 100 to the base 10, and transmit the collision energy to the base 10. In the overlapping portion OR, the collision energy transmitted to the front bracket 200 can be efficiently transmitted to the base 10.

The protective structure 1 transmits collision energy to the base 10 while dispersing the collision energy, and disperses and absorbs the collision energy in the base 10 and the frame FL, so that the adjacent member AD can be prevented from interfering with the air compressor 20 as a protection target member.

Therefore, when a collision occurs in the vehicle, it is possible to effectively prevent interference with a device to be protected.

In the protective structure 1 according to the present embodiment, a fixing direction in which the front bracket 200 is fixed to the lower bracket 100 is directed in a direction orthogonal to the contact surface SF formed by the contact portion 210 protruding.

That is, the collision energy transmitted to the contact portion 210 is transmitted to the front side surface of the lower bracket 100 via the front side surface of the front bracket 200, and is transmitted to the base 10.

The bolts B21 to B23 fixing the front bracket 200 are oriented in a direction orthogonal to the contact surface SF. For example, the bolts B21 to B23 fix the front bracket 200 linearly in the direction in which the contact portion 210 protrudes.

Therefore, the collision energy received by the contact surface SF formed by the protruding contact portion 210 can be efficiently transmitted to the base 10 linearly in the direction of the arrow AR4 via the bolts B21 to B23.

Therefore, when a collision occurs in the vehicle, it is possible to effectively prevent interference with a device to be protected.

In the protective structure 1 according to the present embodiment, at least a part of the fixing direction in which the lower bracket 100 is fixed to the base 10 is directed in a direction different from the fixing direction of the front bracket 200 to the lower bracket 100.

That is, the bolts B21 to B23 and the bolts BS1 to BS2 fixing the front bracket 200 to the base 10 are directed in directions different from the bolts B11 to B13 fixing the lower bracket 100 to the base 10. For example, the bolts B11 to B13 and the bolts BS1 and BS2 are fixed to the base 10 from the upper side to the lower side. Then, the collision energy transmitted to the upper surface of the lower bracket 100 is transmitted to the base 10 via the bolts B11 to B13 and the bolts BS1 and BS2. Then, the collision energy is converted from a direction from the front side to the rear side in the protective structure 1 to a direction from the upper side to the lower side and transmitted to the base 10.

Therefore, the protective structure 1 can limit the collision energy transmitted to the base 10 by converting the direction of the collision energy transmitted from the front bracket 200 to the lower bracket 100 and transmitting the collision energy to the base 10. The base 10 can efficiently absorb the collision energy.

Therefore, when a collision occurs in the vehicle, it is possible to effectively prevent interference with a device to be protected.

Although the embodiment of the disclosure has been described in detail with reference to the drawings, the specific configuration is not limited to the embodiment, and includes a design and the like without departing from the gist of the disclosure.

1. A protective structure comprising:
a frame forming a skeleton of a vehicle;
a base configured to disperse an impact due to a collision to the frame when the collision occurs;
a first bracket fixed to the base; and
a second bracket fixing and supporting a protection target member to be protected from an impact due to the collision, the second bracket being fixed to the first bracket, wherein
the second bracket comprises a contact portion protruding toward an adjacent member disposed adjacent to the second bracket, and
at least a part of the contact portion and a part of the first bracket overlap each other as viewed from a side where the contact portion protrudes.

2. The protective structure according to claim 1, wherein a fixing direction in which the second bracket is fixed to the first bracket is directed in a direction orthogonal to a contact surface formed by the contact portion which is protruding.

3. The protective structure according to claim 2, wherein at least a part of a fixing direction in which the first bracket is fixed to the base is directed in a direction different from the fixing direction of the second bracket to the first bracket.
